(19) United States
(12) Patent Application Publication
(10) Pub. No.: US 2005/0128158 A1
(43) Pub. Date: Jun. 16, 2005

(54) Horizontal polarized wave non-directional array antenna

(75) Inventors: Ryuichi Taira, Tokyo (JP); Shigeru Uchino, Tokyo (JP); Moriyoshi Kawasaki, Tokyo (JP)

Correspondence Address: MCGINN & GIBB, PLLC, 8321 OLD COURTHOUSE ROAD, SUITE 200, VIENNA, VA, 22182-3817, US

(73) Assignee: Harada Industry Co., Ltd., Tokyo (JP)

(21) Appl. No.: 11/001,569

(22) Filed: Dec. 2, 2004

(30) Foreign Application Priority Data
Dec. 3, 2003 (JP) P .2003-404827

(51) Int. Cl. H01Q 9/16

(52) U.S. Cl. 343/793; 343/810

(57) ABSTRACT

A horizontal polarized wave non-directional array antenna, including: an antenna supporting member supported so that an axial direction thereof corresponds to a vertical direction, the antenna supporting member including a pair of feeder lines that are disposed parallel to each other in the axial direction, the antenna supporting member having abase portion; a plurality of dipole antennas arrayed along and connected to the pair of feeder lines; and a balance/unbalance converting portion formed on a feeding side of the base portion for feeding the pair of feeder lines in series.

### BACKGROUND OF THE INVENTION

1. Field of the Invention

The present invention relates to a horizontal polarized wave non-directional array antenna particularly preferable for a base station of a mobile communication system or the like.

2. Background Art

In a background art, there are variously conceived antenna apparatus used at abase station of a mobile communication system of a portable telephone, PHS (personal handy phone system: second generation codeless telephone system) or the like achieving non-directionality in a horizontal face of a horizontal polarized wave. (See, for example, JP-A-11-340733).

### SUMMARY OF THE INVENTION

However, when array antenna formation is conceived for high gain formation, there is brought about a drawback that any of horizontal polarized wave non-directional antennas including one disclosed in JP-A-11-340733, mentioned above, is complicated and fabrication cost is increased, or the structure is conversely excessively simple and a mechanical strength in forming an array cannot be maintained.

The invention has been carried out in view of the above-described circumstances. It is an object thereof to provide a horizontal polarized wave non-directional array antenna having a simple structure, excellent in productivity and capable of ensuring a mechanical strength suitable for installation thereof while realizing sufficient non-directionality in a horizontal face.

The invention provides a horizontal polarized wave non-directional array antenna, including: an antenna supporting member supported so that an axial direction thereof corresponds to a vertical direction, the antenna supporting member including a pair of feeder lines that are disposed parallel to each other in the axial direction, the antenna supporting member having a base portion; a plurality of dipole antennas arrayed along and connected to the pair of feeder lines; and a balance/unbalance converting portion formed on a feeding side of the base portion for feeding the pair of feeder lines in series.

Preferably, each of the plurality of dipole antennas has an antenna length of substantially a half wave length of an object frequency.

Preferably, each of the plurality of dipole antennas is formed in a ring-like shape along a plane substantially orthogonal to an axial directions of the respective feeder lines.

Preferably, a tilt angle of radiation relative to a face orthogonal to a direction of an array of the antennas is set by intervals of the plurality of dipole antennas.

Preferably, the balance/unbalance converting portion includes a matching circuit portion for matching the plurality of dipole antennas.

Preferably, ontal polarized wave non-directional array antenna according to claim 1, wherein the antenna supporting member is made of PPE (PolyPhenylene Ether) or fluororesin.

According to the invention, not only the structure is simple and excellent in productivity and a mechanical strength suitable for installation can be ensured but also a width of the feeder line can be narrowed since series feeding is used, as a result, an outer diameter of a total of the antenna including the antenna supporting member can be made to be small and slender.

Further, according to the invention, for example, the antenna length necessary for PHS using radio wave of 1.9 [GHz] band becomes less than 80 [mm] and the outer diameter of the total of the antenna can be made to be smaller and more slender by devising the shape of the dipole antenna.

Further, according to the invention, there can be constituted a structure extremely rich in realizability such that the excellent non-directionality can be realized in the horizontal face, the diameter of the total of the antenna can be reduced and can be contained in a radome in the shape of a circular pipe.

Further, according to the invention, the necessary tilt angle can easily be set to be variable easily by the interval of the antennas such that for example, when the antenna is set to a house top of a building in an urban area as a base station antenna, the necessary tilt angle is set or the like.

Further, according to the invention, the antenna can be used with a higher antenna efficiency.

Further, according to the invention, matching between the dipole antenna which is an antenna element and input/output cables is easy to carry out and the non-directionality is easy to achieve.

### BRIEF DESCRIPTION OF THE DRAWINGS

The present invention may be more readily described with reference to the accompanying drawings:

FIG. 1 is a view showing a basic structure of a horizontal polarized wave non-directional array antenna for a PHS base station according to an embodiment of the invention.

FIG. 2 is a Smith chart showing a first measurement result according to the embodiment.

FIG. 3 is a diagram showing return loss of the first measurement result according to the embodiment.

FIG. 4 is a diagram showing VSWR of the first measurement result according to the embodiment.

FIG. 5 is a Smith chart showing a second measurement result according to the embodiment.

FIG. 6 is a diagram showing return loss of the second measurement result according to the embodiment.

FIG. 7 is a diagram showing VSWR of the second measurement result according to the embodiment.

FIG. 8 is a diagram showing a radiation pattern in a vertical direction of the first measurement result according to the embodiment.

FIG. 9 is a diagram showing a radiation pattern in a vertical direction of the second measurement result according to the embodiment.

FIG. 10 is a diagram showing a radiation pattern in a horizontal direction of the first measurement result according to the embodiment.

### DETAILED DESCRIPTION OF THE PREFERRED EMBODIMENTS

An explanation will be given of an embodiment when the invention is applied to a base station antenna of PHS using a radio wave of 1.9 [GHz] band in reference to the drawings as follows.

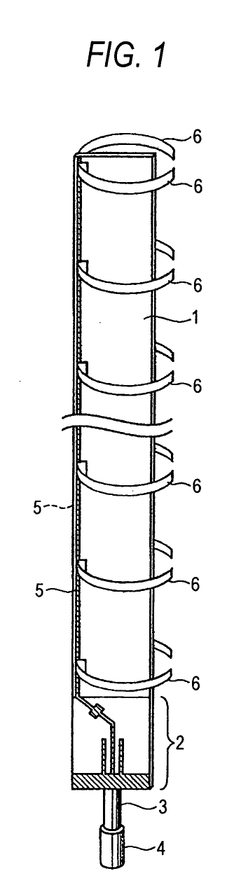

FIG. 1 shows a basic structure of antenna in which a radome is removed. In the drawing, numeral 1 designates an antenna board in a shape of a rectangular plate a direction of a long side thereof is vertically supported. The antenna board 1 is made of, for example, PPE (PolyPhenylene Ether) (dielectric constant about 3.3), fluororesin of teflon (R) (dielectric constant about 2.3) or the like. The antenna board 1 has a feeding base being provided with a balance/unbalance converting portion 2, and connected to a feeder 3 formed by a coaxial cable and including a connector 4 at a front end thereof.

The balance/unbalance converting portion 2 serves also as a matching circuit by, for example, balun. A pair of feeder lines 5, 5 that are parallel with each other are formed respectively on a front face and a back face of one end side of the antenna board 1 along the long side thereof via the balance/unbalance converting portion 2 at a base portion of the antenna board 1.

Further, pluralities of pairs of dipole antennas are formed by arranging antenna elements 6, 6, . . . respectively bent in a semicircular shape and forming pairs along the feeder lines 5, 5 such that the antenna elements 6, 6, . . . are supported by the feeder lines in a horizontal direction. That is, the pair of antenna elements 6, 6 respectively connected to the feeder lines 5, 5 function as a single dipole antenna, and a plurality of pairs thereof are aligned along the long side direction of the antenna board 1 and fed in series with electricity by the feeder lines 5, 5.

According to the pair of antenna elements 6, 6 constituting each dipole antenna, antenna lengths in sum are set to be substantially λ/2 (λ: wave length) of an object frequency and in this case, when the object frequency is set to 1900 [GHz], λ/2 becomes about 78 [mm].

In addition thereto, a diameter of the dipole antenna in a ring-like shape is set to 0.18λ, that is, about 28 [mm].

Further, an array interval of the above-described respective dipole antennas are set to be variable by a necessary tilt angle relative to the horizontal direction. Specifically, when the array interval is set to 100 [mm] in correspondence with 1λ on the board, tilting is not carried out and radiation is carried out in a horizontal direction.

On the other hand, when the array interval of the respective dipole antennas is made to be smaller than 100 μm), mentioned above, tilting is carried out in a feeding direction, a lower direction of paper face in FIG. 1. In contrast, when the array interval is made to be larger than 100 [mm], tilting is carried out in a direction reverse to the feeding direction, or upper direction of paper face in FIG. 1.

An explanation will be given of various characteristics provided as a result of an experiment as follows in the above-described constitution.

### FIRST MEASUREMENT EXAMPLE

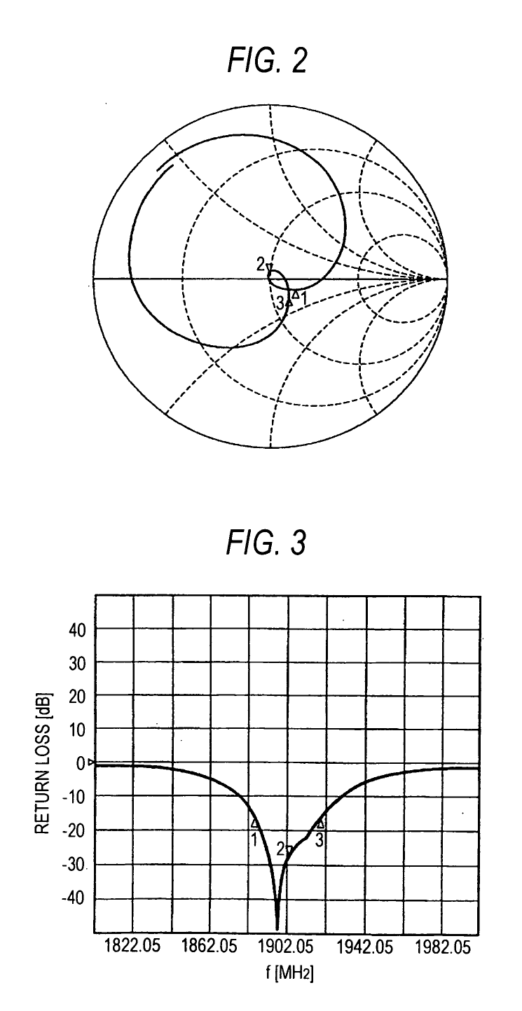

FIG. 2 through FIG. 4 and FIG. 8 show a measurement result when the respective array intervals of the dipole antennas are set to 100 [mm] to constitute the tilt angle in the horizontal direction to be 0° and dipole antennas by the antenna elements 6, 6, . . . are constituted as 16 pairs.

In this case, markers ‘1’ through ‘3’ shown by triangular marks in the drawings to cover a frequency band of PHS take following frequency values. That is,
marker ‘1’: 1884.65 [MHz]
marker ‘2’: 1902.05 [MHz]
marker ‘3’: 1919.45 [MHz]

FIG. 2 is a Smith chart indicating a result of measurement over a range of 200 [MHz] centering on the frequency 1902.05 [MHz] of the above-described marker ‘2’.

Here, the marker ‘1’ is about 67 [Ω], the marker ‘2’ is about 49 [Ω], the marker ‘3’ is about 62 [Ω] and the marker ‘2’ of the center frequency takes a value approximated to an ideal value 50 [Ω] and therefore, it can be determined that substantially a desired characteristic can be realized.

FIG. 3 shows return loss, return loss of the masker ‘1’ of the above-described frequency is −16.277 [dB], return loss of the marker ‘2’ is −27.812 [dB] and return loss of the marker ‘3’ is −16.646 [dB] and it is known that the return loss can be restrained to be equal to or smaller than −14 [dB] over a frequency range necessary for PHS.

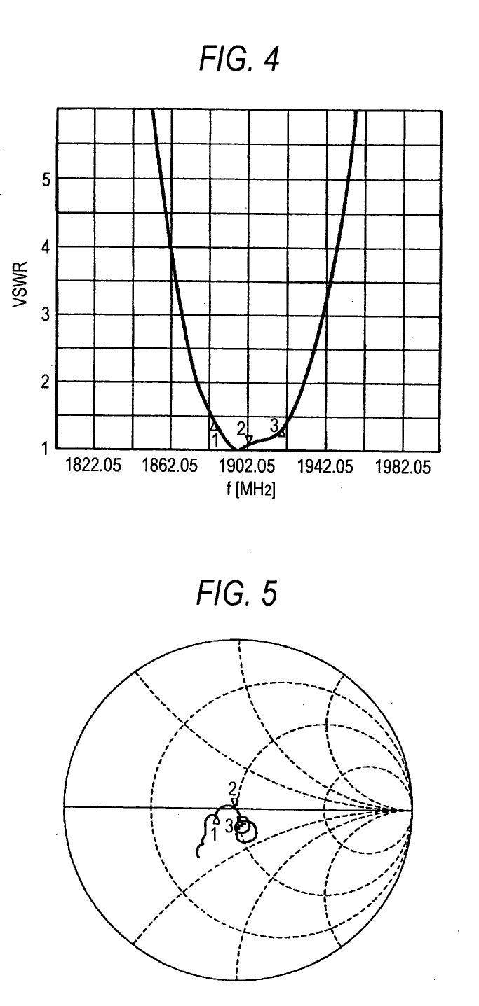

The point is significant also in VSWR (voltage standing wave ratio) of FIG. 4, VSWR of the marker ‘1’ having the above-described frequency takes a value of 1.3637, VSWR of the marker ‘2’ takes a value of 1.0848, and VSWR of the marker ‘3’ takes a value of 1.3455 and it is known that VSWR can be restrained to be equal to or smaller than 1.5 over the frequency range necessary for PHS.

It is known from the result of FIG. 2 through FIG. 4, that there is constituted an antenna structure in which reflection or the like is extremely small in feeding and which can be driven to radiate very efficiently.

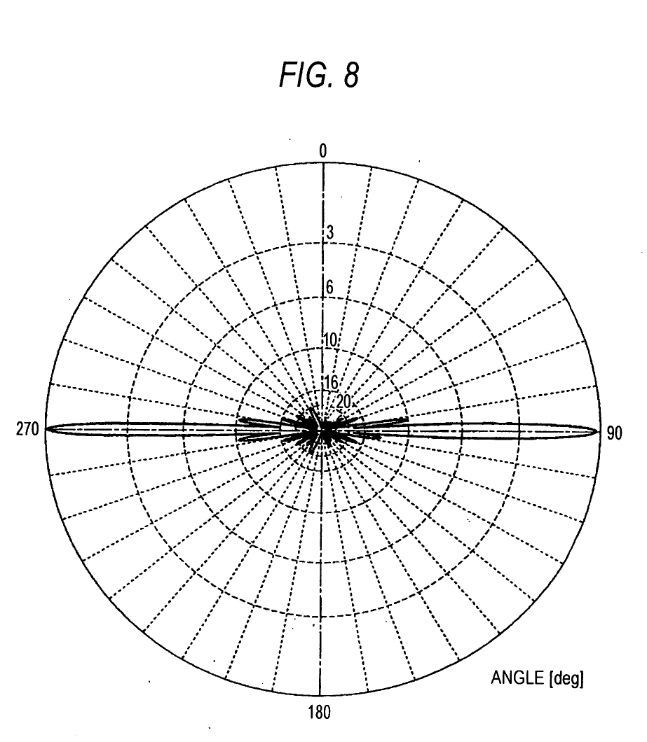

FIG. 8 shows an example of measuring a radiation pattern in a vertical face. It can be understood that antenna radiation is carried out in the horizontal face by setting the tilt angle substantially to 0 degree as described above. Therefore, by forming the antenna structure with thus setting numerical characteristics or the like, when a base station is located at suburbs or the like where a population density is comparatively low and transmission and reception need to carry out over a wide range, the antenna emphasizing the characteristic in the horizontal face without setting the tilt angle of this kind is used.

### SECOND MEASUREMENT EXAMPLE

FIG. 5 through FIG. 7 and FIG. 9 show a measurement result when the respective array intervals of the dipole antennas are set to 93 [mm] to constitute the tilt angle of 8° (in lower direction of feeding side) and the dipole antennas by the antenna elements 6, 6, . . . are constituted by 20 pairs.

Also in this case, the markers ‘1’ through ‘3’ indicated by the triangular marks in the drawings to cover the frequency band of PHS take the following values of frequencies. That is,
marker ‘1’: 1884.65 [MHz]
marker ‘2’: 1902.05 [MHz]
marker ‘3’: 1919.45 [MHz]

FIG. 5 is a Smith chart showing a result of measuring over a range of 200 [MHz] centering on the frequency 1902.05 [MHz] of the above-described marker ‘2’.

Here, the marker ‘1’ is about 39 [Ω], the marker ‘2’ is about 48 [Ω], the marker ‘3’ is about 50 [Ω], the marker ‘2’ of the center frequency and the marker ‘3’ take values substantially approximated to an ideal value 50 [Ω] and therefore, it can be determined that substantially a desired characteristic can be realized.

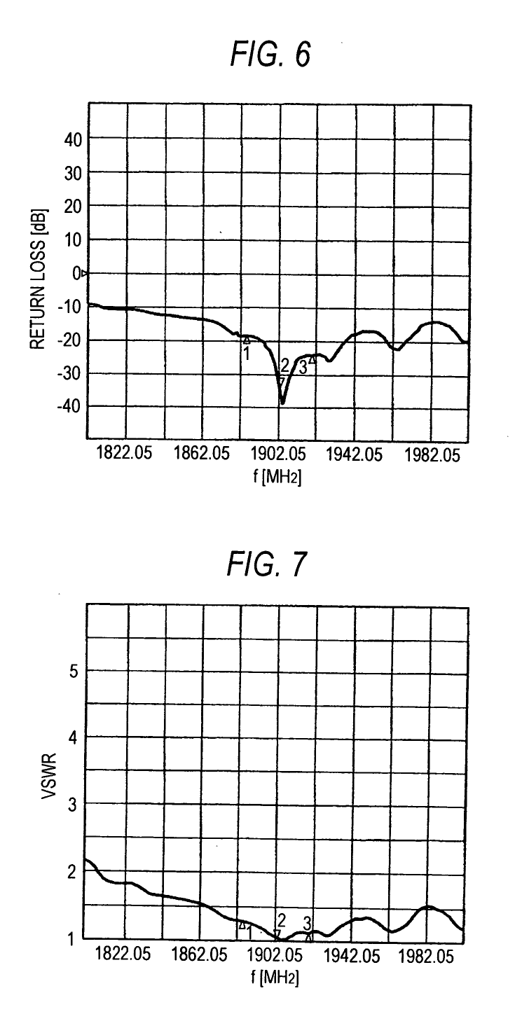

FIG. 6 shows return loss, return loss of the marker ‘1’ having the above-described frequency is −17.700 [dB], return loss of the marker ‘2’ is −33.179 [dB], and return loss of the marker ‘3’ is −23.591 [dB] and it can be understood that the return loss can be restrained to be equal to or smaller than −14 [dB] over the frequency range necessary for PHS.

The point is significant also in VSWR of FIG. 7, VSWR of the marker ‘1’ having the above-described frequency takes a value of 1.2996, VSWR of the marker ‘2’ takes a value of 1.0448, and VSWR of the marker ‘3’ takes a value of 1.1415 and it is known that VSWR can be restrained to be equal to or smaller than 1.5 with sufficient allowance over the frequency range necessary for PHS.

It is known from the result of FIG. 5 through FIG. 7, that there is constituted an antenna structure in which reflection or the like is extremely small in feeding and which can be driven to radiate very efficiently.

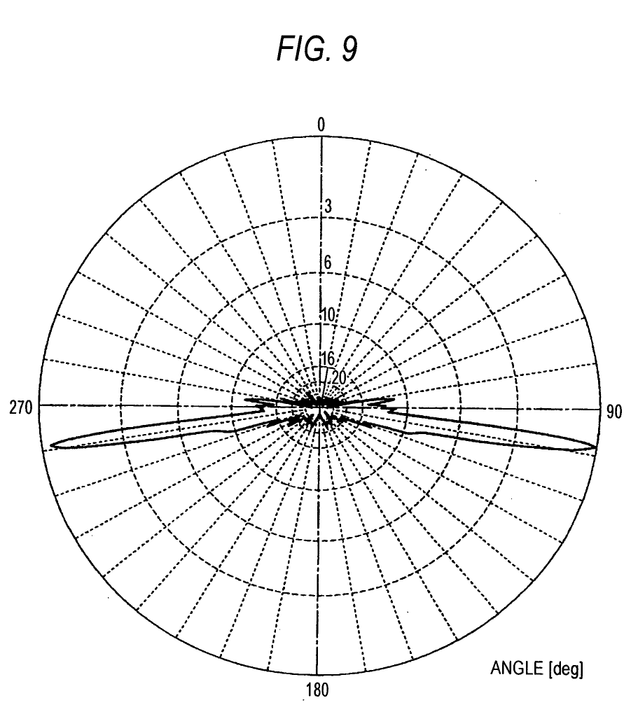

FIG. 9 shows an example of measuring a radiation pattern of a vertical face and as described above, the tilt angle is substantially set to 8 degrees (in lower direction). Therefore, by forming the antenna structure with thus setting numerical values or the like, when a base station is located on, for example, a roof of a building in an urban area or the like where the population density is comparatively high, and transmission and reception need to carry out in a limited range, the antenna of this kind set to the tilt angle more less downward from the horizontal face is used.

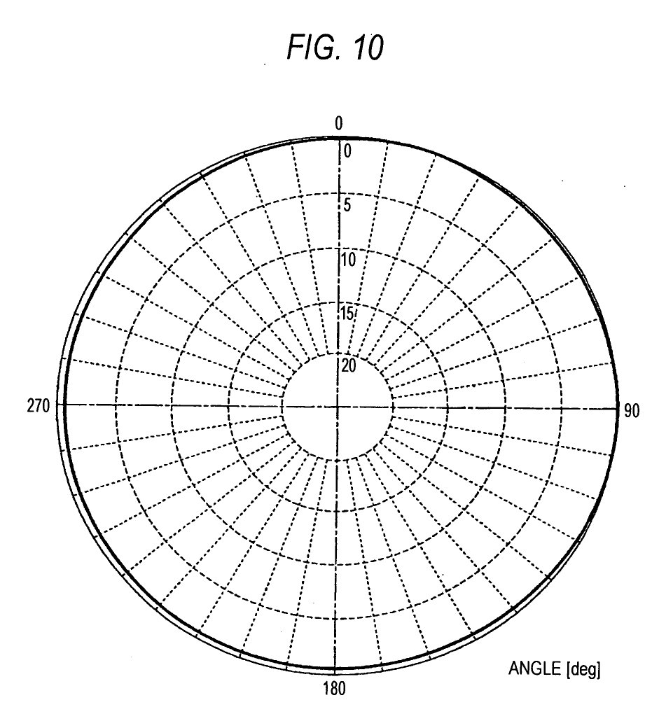

Finally, FIG. 10 shows a radiation pattern in a horizontal face when the tilt angle is set to 0° which has been explained in the above-described first measurement example. As shown in FIG. 10, there is achieved an excellent radiation characteristic uniformly substantially over an entire periphery of 360°, and it can be regarded that a desired non-directionality can be realized substantially perfectly.

In this way, by employing the antenna structure as shown in FIG. 1, and by making a short side of the antenna board 1 equal to or smaller than an outer diameter of the dipole antenna in the ring-like shape as illustrated, a total of the antenna can be accommodated inside of a radome in a shape of a circular pipe.

The point is also brought from the fact that a dimension in a direction of the short side of the antenna board 1 including the interval of the pair of the feeder line can be set to be small by feeding electricity to the antenna elements 6, 6, . . . in series via the pair of parallel feeder lines 5, 5. Not only the structure of the antenna per se is simple and excellent in productivity and the mechanical strength suitable for installation can be ensured but also the outer diameter of the total of the antenna including the antenna board 1 can be made to be small and slender.

Therefore, while ensuring excellent non-directionality and an antenna efficiency, mentioned above, the antenna can be constituted to be very compact, easy in handling of installation or the like and excellent in weather resistance.

Further, when the dimension in the short side direction of the antenna board 1 shown in FIG. 1 is set to be substantially equal to the diameter of the dipole antennas in the ring-like shape and front ends of the respective antenna elements constituting the dipole antennas are respectively supported by an end portion of the antenna board 1 on a side opposed to a side of providing the feeder lines 5, 5 of the antenna board 1, the mechanical strength of the antenna elements 6, 6, . . . can further be increased.

Further, the invention is not limited to the shape of the rectangular plate shape as in the antenna board 1 but, for example, an antenna supporting member in a shape of a round bar may be provided with the balance/unbalance converting portion 2 and the feeder lines 5, 5 and aligned with the antenna elements 6, 6, . . .

Further, although according to the above-described embodiments, an explanation has been given of the case of applying the embodiments to the base station antenna of PHS using radio wave of 1.9 [GHz] band, the invention is not limited to the frequency band used or use, a shape or an interval of aligning, or a number of aligning respective antenna elements or the like.

Otherwise, the invention is not limited to the above-described embodiments but can be embodied by being variously modified within the range not deviated from a gist thereof.

Further, the above-described embodiments include various stages of inventions and various inventions can be extracted by pertinently combining a plurality of constituent essential conditions disclosed. For example, even when several constituent essential conditions are deleted from the total constituent essential conditions showing the embodiments, at least one of the problems described in the problems to be resolved by the invention can be resolved and when at least one of effects described in the effect of the invention is achieved, a constitution in which the constituent essential condition is deleted can be extracted as the invention.

1. A horizontal polarized wave non-directional array antenna, comprising:
an antenna supporting member supported so that an axial direction thereof corresponds to a vertical direction, the antenna supporting member including a pair of feeder lines that are disposed parallel to each other in the axial direction, the antenna supporting member having a base portion;
a plurality of dipole antennas arrayed along and connected to the pair of feeder lines; and
a balance/unbalance converting portion formed on a feeding side of the base portion for feeding the pair of feeder lines in series.

2. The horizontal polarized wave non-directional array antenna according to claim 1,
wherein each of the plurality of dipole antennas has an antenna length of substantially a half wave length of an object frequency.

3. The horizontal polarized wave non-directional array antenna according to claim 1,
wherein each of the plurality of dipole antennas is formed in a ring-like shape along a plane substantially orthogonal to an axial directions of the respective feeder lines.

4. The horizontal polarized wave non-directional array antenna according to claim 1,
wherein a tilt angle of radiation relative to a face orthogonal to a direction of an array of the antennas is set by intervals of the plurality of dipole antennas.

5. The horizontal polarized wave non-directional array antenna according to claim 1,
wherein the balance/unbalance converting portion includes a matching circuit portion for matching the plurality of dipole antennas.

6. The horizontal polarized wave non-directional array antenna according to claim 1,
wherein the antenna supporting member is made of PPE (PolyPhenylene Ether) or fluororesin.
